(19) United States
(12) Patent Application Publication
(10) Pub. No.: US 2024/0416498 A1
(43) Pub. Date: Dec. 19, 2024

(54) POLE TO ACCESSORY CONNECTOR

(71) Applicant: Techtronic Cordless GP, Anderson, SC (US)

(72) Inventors: Trevor Fauss, Greenville, SC (US); Jeremy Fedrigon, Greenville, SC (US); Thomas Evatt, Six Mile, SC (US)

(21) Appl. No.: 18/743,300

(22) Filed: Jun. 14, 2024

Related U.S. Application Data
(60) Provisional application No. 63/521,557, filed on Jun. 16, 2023.

(51) Int. Cl. B25G 3/18; B25G 3/20; B25G 3/28

(52) U.S. Cl. CPC B25G 3/18; B25G 3/20; B25G 3/28

(57) ABSTRACT

Accessory connectors, mounting connector systems, and associated methods are provided. An accessory connector includes a tubular main body that extends from a first end to a second end. The tubular main body defines a pair of connector apertures between the first end and the second end. The accessory connector is removably connectable to the elongate pole and movable between a disconnected position and a connected position in which the pair of buttons extend through the pair of connector apertures.

### PRIORITY STATEMENT

The present application claims priority to U.S. Provisional Patent Application Ser. No. 63/521,557 filed Jun. 16, 2023, which is incorporated by reference herein in its entirety.

### FIELD

The present disclosure relates generally to a connector and connection method from a pole to an accessory.

### BACKGROUND

Hand tools and accessories utilized with a pole, such as brooms, mops, brushes, nets, sponges, and the like, may be moved frequently between a storage space and a workspace. Additionally, the pole may be frequently swapped between different accessories depending on the desired task. One aspect of accessibility is a user's ability to quickly store a tool or accessory and remove the tool from storage. Another aspect of accessibility is the connection systems ability to engage many objects with a standardized connection mechanism between the pole and the accessory.

Accordingly, improved connection systems are desired in the art. In particular, improved connections between an elongated pole and a tool or accessory are desired. For instance, improvements in connection or disconnection between the elongated pole and the accessory are desired. Moreover, improvements in mounting or storage of a modular tool including an elongated pole and a tool or accessory are desired.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIGS. 1A-B illustrate a perspective view of an elongated pole and a broom attachment in accordance with embodiments of the present disclosure;

FIG. 2 is perspective view of an elongated pole coupled with an accessory connector in accordance with embodiments of the present disclosure;

FIG. 3 illustrates a perspective view of the mounting connector system in a fully exploded position in accordance with embodiments of the present disclosure;

FIG. 4 illustrates a perspective view of a mounting connector system in a fully exploded position in accordance with embodiments of the present disclosure;

FIG. 5 illustrates a perspective view of the mounting connector system in a fully connected position in accordance with embodiments of the present disclosure;

FIG. 6 illustrates a perspective view of the mounting connector system in the fully connected position in accordance with embodiments of the present disclosure;

FIG. 7 illustrates a side view of a portion of an elongate pole in accordance with various aspects of the present disclosure;

FIG. 8 illustrates a side view of a portion of an elongate pole in accordance with various aspects of the present disclosure;

FIG. 9 illustrates a side view of an accessory connector in accordance with embodiments of the present disclosure;

FIG. 10 illustrates a side view of an accessory connector in accordance with embodiments of the present disclosure;

FIG. 11 illustrates a perspective view of a mounting connector in accordance with exemplary aspects of the present disclosure;

FIG. 12 illustrates a top view of a mounting connector in accordance with exemplary aspects of the present disclosure;

FIG. 13 shows various attachments that may be compatible with one or more embodiments of the present disclosure; and

FIG. 14 is a flow chart of a method for using a mounting connector system in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes.” “including.” “has.” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus, Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The term “radially” refers to the relative direction that is substantially perpendicular to an axial centerline of a particular component; the term “axially” refers to the relative direction that is substantially parallel and/or coaxially aligned to an axial centerline of a particular component; and the term “circumferentially” refers to the relative direction that extends around the axial centerline of a particular component.

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The accompanying figures and description illustrate embodiments of connectors and connection methods in accordance with various embodiments of the present disclosure.

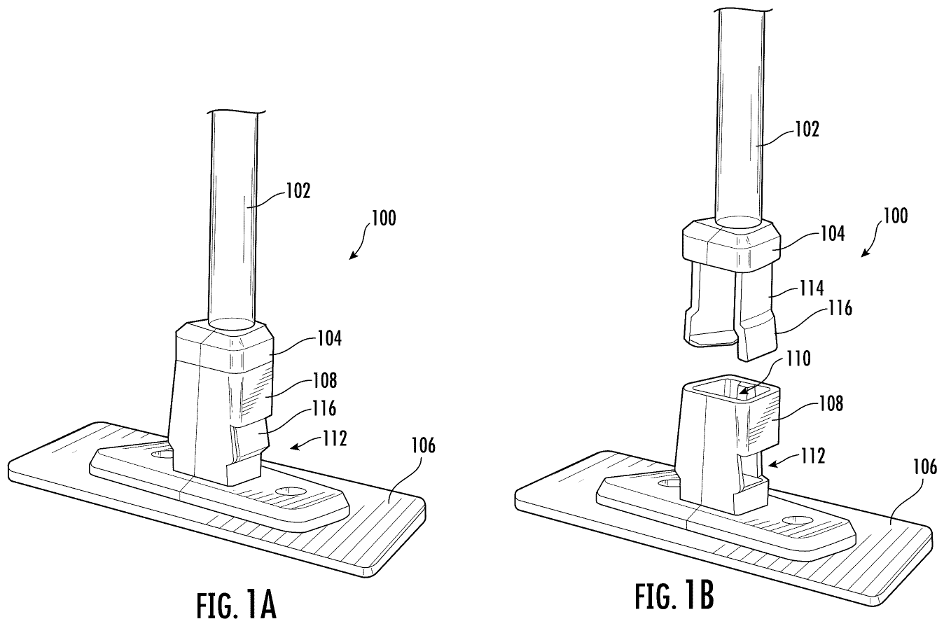

FIGS. 1A-B illustrate a modular tool 100 that includes an elongated pole 102 and an accessory 106. In particular, FIGS. 1A-B illustrate an elongated pole 102 having a buckle connector 104 that is coupled to an accessory 106 (FIG. 1A), such as a broom or mop head, and uncoupled from the accessory 106 (FIG. 1B). Particularly, FIG. 1A illustrates the buckle connector 104 in a connected position, and FIG. 1B illustrates the buckle connector 104 in a disconnected position. The accessory 106 may be connected to an accessory connector 108, which removably couples the accessory 106 to the elongated pole 102. For instance, the accessory connector 108 may have an axial opening 110 configured to receive the buckle connector 104 therein and may define one or more side openings 112. The buckle connector 104 of the elongate pole 102 may have one or more arms 114 at an end thereof, the arms 114 each having one or more button protrusions 116. The button protrusions 116 may be configured to extend through the side openings 112 when the elongate pole 102 is inserted into the axial opening 110 of the accessory connector 108. In one embodiment, as illustrated in FIGS. 1A-B, the button protrusions 116 and the side openings 112 may have a complementary shape and size (e.g., within 10%) such that the button protrusions 116 protrude through the entire opening 112. In other embodiments, the button protrusions 116 may have a smaller shape or size than the side openings 112. To release the coupling between the button protrusions 116 and the side openings 112, the button protrusions may be pressed radially inward from the side openings 112 until the buttons are recessed within the accessory connector 108, and the elongate pole 102 can be removed through the axial opening 110.

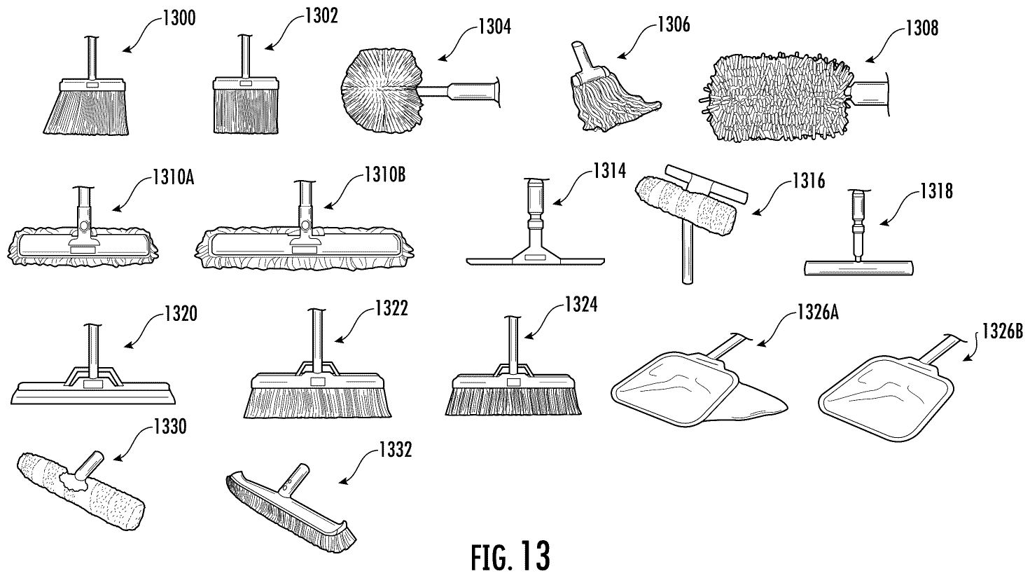

While FIGS. 1A and 1B show a broom attachment, one or more embodiments of the present disclosure may be compatible with various other attachments. As non-limiting examples, as shown in FIG. 13, one or more embodiments of the present disclosure may be compatible with a multi-purpose angle broom 1300, e.g., a 12″ multi-purpose angle broom; a smooth surface straight broom 1302, e.g., a 12″ smooth surface straight broom; a cobb web duster 1304; a standard mop 1306; a flexible microfiber duster 1308; a microfiber mop 1310A and 1310B, e.g., a 12″ microfiber mop 1310A or a 24″ microfiber mop 1310B; a squeegee 1314, e.g., 12″ squeegee; a squeegee and scrubber 1316, e.g., a 14″ squeegee and scrubber; a window scrubber 1318, e.g., a 14″ window scrubber; a floor squeegee 1320, e.g., a 24″ floor squeegee; a multi-purpose push broom 1322, e.g., a 24″ multi-purpose push broom; a smooth surface push broom 1324, e.g., a 24″ smooth surface push broom; a pool rake 1326A and 1326B; a pool skimmer 1330; a 270-degree pool brush; and a standard pool brush 1332. While the accessories described above provide various examples, the accessory connector and mounting connector system described herein should not be limited to any particular accessory unless specifically recited in the claims. Additionally, a person of ordinary skill in the art would understand that one or more embodiments of the present disclosure may be compatible with various other attachments as well that are not listed above.

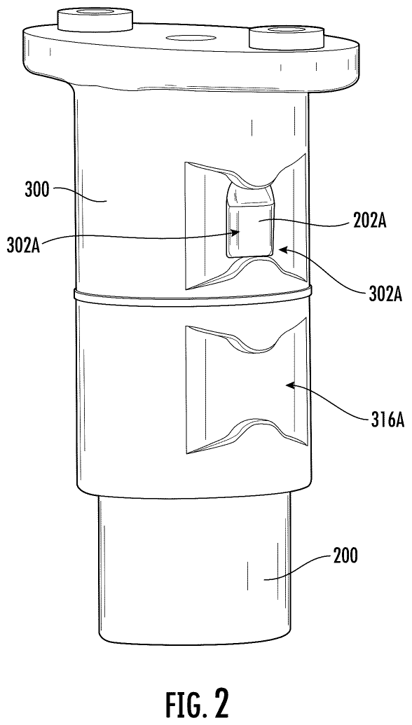

FIG. 2 illustrates a close up view of an elongate pole 200 (such as a broom handle or other elongate pole) and accessory connector 300 coupled together. The elongate pole 200 may include a pair of buttons 202A (only one button of the pair of buttons is shown). The accessory connector 300 is configured to couple with an accessory, such as any of the accessories described above with reference to FIG. 13 (e.g. a broom brush, mop, pool cleaning attachment, or any other suitable accessory useful to be attached to an elongate pole 200). In the embodiment of FIG. 2, the accessory connector 300 includes multiple pairs of mounting recesses 314A, 316A (only one of each pair is shown) and a pair of connector apertures 302A (only one connector aperture of the pair of connector apertures is shown). As discussed further below, the pair of mounting recesses may be configured to connect with a mounting connector 400 (FIGS. 3-6), and the pair of connector apertures may receive the button protrusions 202 of the elongate pole 200 therethrough.

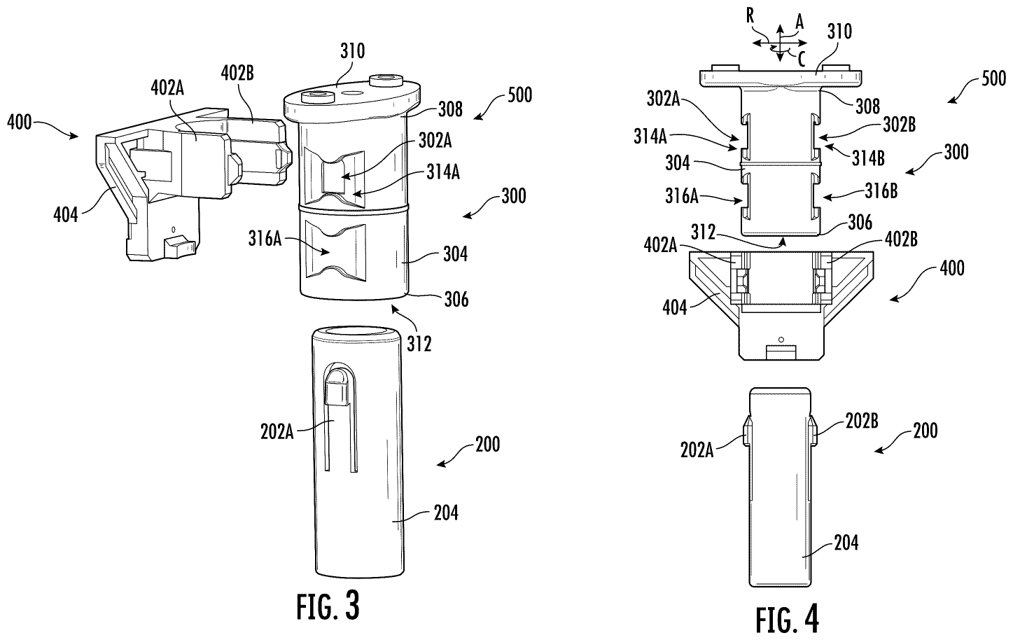

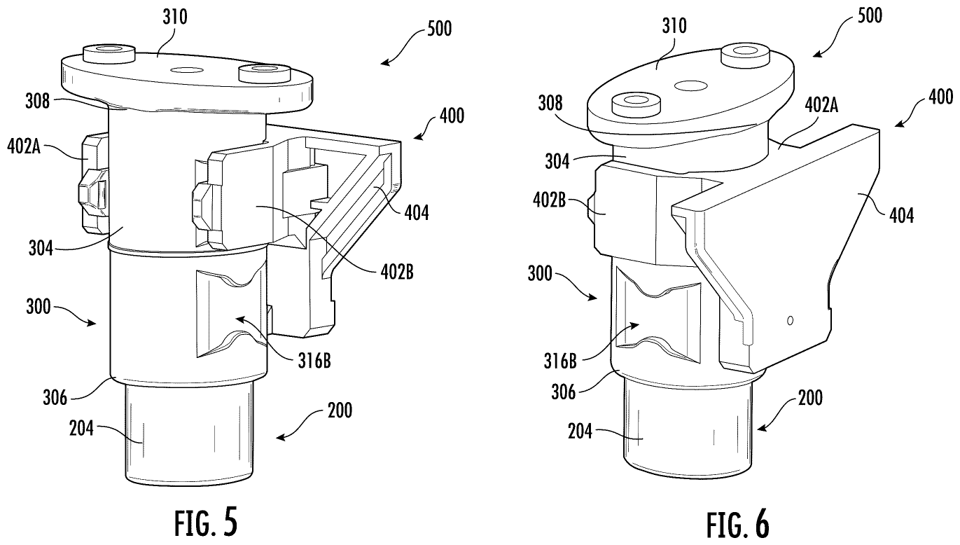

Referring now to FIGS. 3 through 6, various views of a mounting connector system 500 are illustrated in accordance with embodiments of the present disclosure. Particularly, FIG. 3 illustrates a perspective view of the mounting connector system 500 in a fully exploded position (or disconnected position); FIG. 4 illustrates another perspective view of the mounting connector system 500 in a fully exploded position (or disconnected position); FIG. 5 illustrates a first perspective view of the mounting connector system 500 in a fully connected position; and FIG. 6 illustrates a second perspective view of the mounting connector system 500 in the fully connected position.

As shown in FIG. 4, the mounting connector system 500 may define a cylindrical coordinate system having an axial direction A extending along an axial centerline of the elongate pole 200 and/or the accessory connector 300 (which may share an axial centerline when coupled to one another); a radial direction R extending perpendicularly to the axial direction A; and a circumferential direction C extending about the axial direction A.

The mounting connector system 500 may include the elongate pole 200, an accessory connector 300 removably couplable to the elongate pole 200, and a mounting connector removably couplable to the accessory connector 300 (with or without the elongate pole 200 attached thereto). The elongate pole 200 may include a main body 204 (such as a cylindrical or tubular main body) and a pair of buttons 202A, 202B defined in the main body 204. Particularly, as shown in FIG. 4, the pair of buttons 202A, 202B may include a first button 202A and a second button 202B oppositely oriented from one another and each extending radially outwardly from the main body 204 of the elongate pole 200.

The mounting connector 400 may include a bracket body 404 and a pair of connector arms 402A, 402B extending from the bracket body 402. The pair of connector arms 402A, 402B may include a first connector arm 402A and a second connector arm 402B. In many embodiments, the pair of connector arms 402A, 402B may be spaced apart from one another (e.g., approximately the width of the elongate pole 200), and the pair of connector arms 404A, 402B may be generally parallel to one another.

The accessory connector 300 may include a tubular main body 304 that extends (e.g., axially) between a first end 306 and a second end 308. Additionally, the accessory connector 300 may include an accessory mounting portion 310 extending from the second end 308 of the tubular main body 304 for connecting to an accessory (such as any of the accessories shown and described with reference to FIG. 13). The tubular main body 304 may define an axial opening 312 at the first end 306, which may be sized to receive the elongate pole 200 when coupling the elongate pole 200 to the accessory connector 300.

Additionally, in exemplary embodiments, the tubular main body 304 may define a pair of connector apertures 302A, 302B and a pair of mounting recesses (such as a first pair of mounting recesses 314A, 314B and a second pair of mounting recesses 316A, 316B) between the first end 306 and the second end 308. the accessory connector 300 may be removably connectable to the elongate pole 200 and movable between a disconnected position (FIGS. 3 and 4) and a connected position (FIGS. 5 and 6) in which the pair of buttons 202A, 202B extend through the pair of connector apertures 302A, 302B.

For example, to connect the elongate pole 200 to the accessory connector 300, the elongate pole 200 may be inserted into the axial opening 312 such that an interior surface of the accessory connector 300 compresses the pair of buttons 202A, 202B (thereby forcing them radially inwards) until the pair of buttons 202A, 202B align with the pair of connector apertures 302A, 302B. At which point, the pair of buttons 202A, 202B may decompress and extend through the pair of connector apertures 302A, 302B, thereby coupling the accessory connector 300 to the elongate pole 200. the pair of buttons 202A, 202B and the connector apertures 302A, 302B may have a complementary shape and size (e.g., within 10%) such that the button pair of buttons 202A, 202B each protrude through an entirety of a corresponding connector aperture 302A, 302B. In other embodiments, the pair of buttons 202A, 202B may have a smaller shape or size than the pair of connector apertures 302A, 302B.

In exemplary embodiments, as shown, the accessory connector 300 may be mountable (or removably connectable) to the mounting connector 400 and movable between an unmounted position (FIGS. 3 and 4) and mounted position (FIGS. 5 and 6) in which the pair of connector arms 402A, 402B extend into the pair of mounting recesses (such as the first pair of mounting recesses 314A, 314B or second pair of mounting recesses 316A, 316B). As shown in FIGS. 5 and 6, the pair of connector arms 402A, 402B may contact and compress the pair of buttons 202A, 202B when in the mounted position such that the elongate pole 200 is removable from the accessory connector 300 when in the mounted position while the accessory connector 300 may remain mounted to the mounting connector 400.

As shown, the pair of connector apertures 302A, 302B may align with and be defined through the first pair of mounting recesses 314A, 314B. By contrast, the second pair of mounting recesses 316A, 316B may not include any apertures and may be solid, such that the mounting connector 400 may optionally be coupled to the accessory connector 300 without also decoupling the elongate pole 200. That is, the mounting connector 400 may mount (or connect) to both the accessory connector 300 and the elongate pole 200 or just the accessory connector 300 depending on what is desired.

For example, to mount the accessory connector 300 to the mounting connector 400 and also decouple the elongate pole 200 from the accessory connector 300, the pair of connector arms 402A, 402B may be forced over the first pair of recesses 314A, 314B, thereby causing the pair of connector arms 402A, 402B to engage and compress the pair of buttons 202A, 202B through the pair of connector apertures 302A, 302B. Subsequently, the elongate pole 200 may be axially removed from the elongate pole 200 by pulling the elongate pole 200 through the axial opening 312, which leaves the accessory connector 300 (as well as any accessory connected thereto) mounted to the mounting connector 400. In this way, the mounting connector 400 may be utilized for quickly decoupling the accessory connector 300 from the elongate pole 200 while simultaneously mounting to the accessory connector 300. Alternatively, to mount the accessory connector 300 to the mounting connector 400 without decoupling the elongate pole 200 from the accessory connector 300, the pair of connector arms 402A, 402B may be forced over the second pair of recesses 316A, 316B.

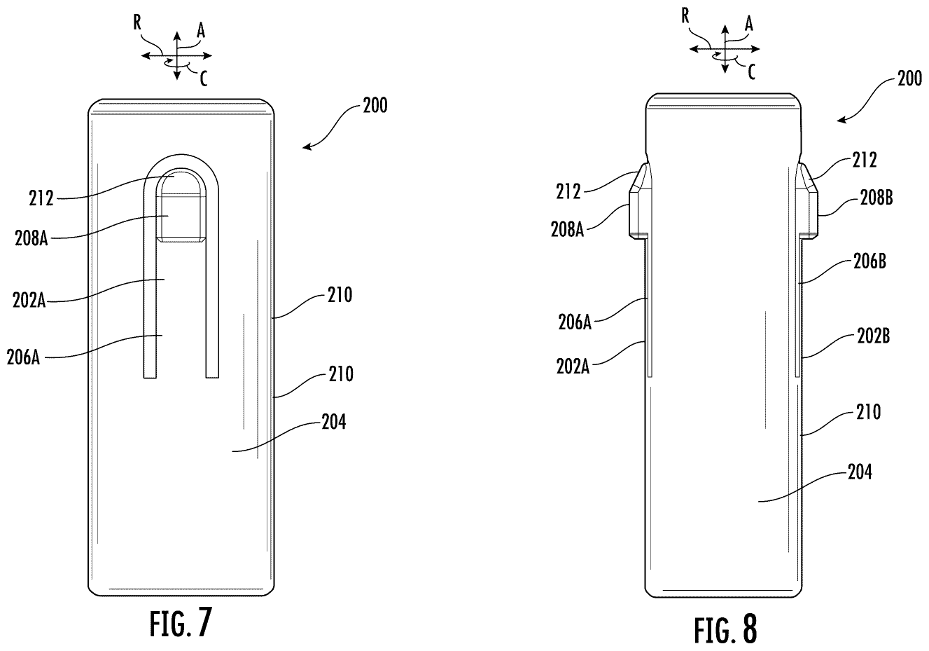

Referring now to FIGS. 7 and 8, two different side views of a portion of an elongate pole 200 are illustrated in accordance with embodiments of the present disclosure, such as the elongate pole that may be included in the mounting connector system 500 described above with reference to FIGS. 3 through 6. As shown, the elongate pole 200 may include the main body 204 and the pair of buttons 202A, 202B defined in the main body 204. The pair of buttons 202A, 202B may include a first button 202A and a second button 202B each defined in the main body 204 across from one another (e.g., diametrically opposed from one another). Each button of the pair of buttons 202A, 202B may include a tab portions 206A, 206B (such as a first tab portion 206A and a second tab portion 206B) and button protrusion portions 208A, 208B (such as a first button protrusion portion 208A and a second button protrusion portion 208B). The tab portions 206A, 206B may each extend (e.g., generally axially) from the main body 204 and may be flush with an exterior surface 210 of the main body 204. The button protrusion portions 208A, 208B may each extend (e.g., generally axially) from a respective tab portion 206A, 206B to a respective terminal end. The button protrusion portions 208A, 208B may each protrude radially outwardly from the exterior surface of the main body 204. When the accessory connector 300 is coupled to an elongate pole 200 (as shown in FIG. 2) only the button protrusion portions 208A, 208B may each extend through a respective connector aperture 302A, 302B, while the tab portions 206A, 206B remain within the accessory connector 300. Lastly, as shown, each of the button protrusion portions 208A, 208B may include a sloped surface 212 extending to the terminal end of the respective button 202A, 202B, which advantageously permits the elongate pole 200 to be slid into the axial opening 312 of the accessory connector 300 with minimal resistance.

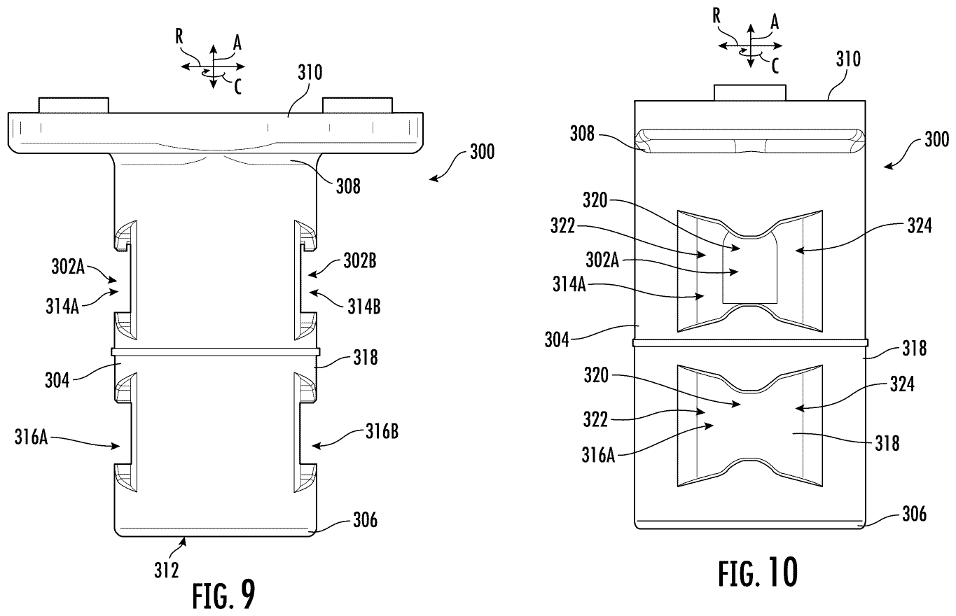

Referring now to FIGS. 9 and 10, two perspective views of an accessory connector 300 are illustrated in accordance with embodiments of the present disclosure, such as the accessory connector 300 that may be included in the mounting connector system 500 described above with reference to FIGS. 3 through 6. Notably, while FIG. 10 only illustrates a first side of the accessory connector 300, it should be appreciated that the second side includes similar or the same features.

The accessory connector 300 may include the tubular main body 304 that extends (e.g., axially) between a first end 306 and a second end 308. Additionally, the accessory connector 300 may include an accessory mounting portion 310 extending from the second end 308 of the tubular main body 304 for connecting to an accessory (such as any of the accessories shown and described with reference to FIG. 13). The tubular main body 304 may define an axial opening 312 at the first end 306, which may be sized to receive the elongate pole 200 when coupling the elongate pole 200 to the accessory connector 300. Additionally, in exemplary embodiments, the tubular main body 304 may define a pair of connector apertures 302A, 302B and a pair of mounting recesses (such as a first pair of mounting recesses 314A, 314B and a second pair of mounting recesses 316A, 316B) between the first end 306 and the second end 308.

The first pair of mounting recesses 314A, 314B may include a first mounting recess 314A and a second mounting recess 314B. Each mounting recess in the first pair of mounting recesses 314A, 314B may be recessed (e.g., radially) from an exterior surface 318 of the tubular main body 304. Additionally, each mounting recess in the first pair of mounting recesses 314A, 314B may be diametrically opposed from one another. The first pair of mounting recesses 314A, 314B may be disposed proximate (e.g. axially closer to) the second end 308 than the first end 306.

Similarly, the second pair of mounting recesses 316A, 316B may include a third mounting recess 316A and a fourth mounting recess 316B. Each mounting recess in the second pair of mounting recesses 316A, 316B may be recessed (e.g., radially) from an exterior surface 318 of the tubular main body 304. Additionally, each mounting recess in the second pair of mounting recesses 316A, 316B may be diametrically opposed from one another. The second pair of mounting recesses 316A, 316B may be disposed proximate (e.g. axially closer to) the first end 306 than the second end 308. The first pair of mounting recesses 314A, 314B and the second pair of mounting recesses 316A, 316B may be axially spaced apart from one another (but radially aligned).

Each mounting recess in each pair of mounting recesses 314A, 314B, 316A, 316B may include a “bowtie shape.” However, it should be appreciated that other suitable shapes are possible, including but not limited to a triangle, quadrilateral, or other pentagon, or a circle, or other rounded or arcuate shape, and the present invention should not be limited to any particular shape unless specifically recited int the claims.

Particularly, as shown in FIG. 10, each mounting recess in each pair of mounting recesses 314A, 314B, 316A, 316B may include a middle portion 320, a first wing portion 322 extending from the middle portion 320, and a second wing portion 324 extending from the middle portion 320. The middle portion 320 may have the smallest axial length, and the wing portions 322, 324 may diverge axially outwardly as they each extend from the middle portion 320. As shown, the pair of connector apertures 302A, 302B may be aligned with and defined through the first pair of mounting recesses 314A, 314B. Particularly, the pair of connector apertures 302A, 302B may be aligned with and defined through the first pair of mounting recesses 314A, 314B at the middle portion 320.

Additionally, as shown in FIG. 10, each mounting recess in the second pair of mounting recesses 316A, 316B may include a solid surface 326. The solid surface 326 may not include any voids, apertures, holes, or other openings that connect the exterior of to the interior of the accessory connector 300. This permits the mounting connector 400 to be optionally coupled with the accessory connector 300 without compressing the buttons of the elongate pole 200.

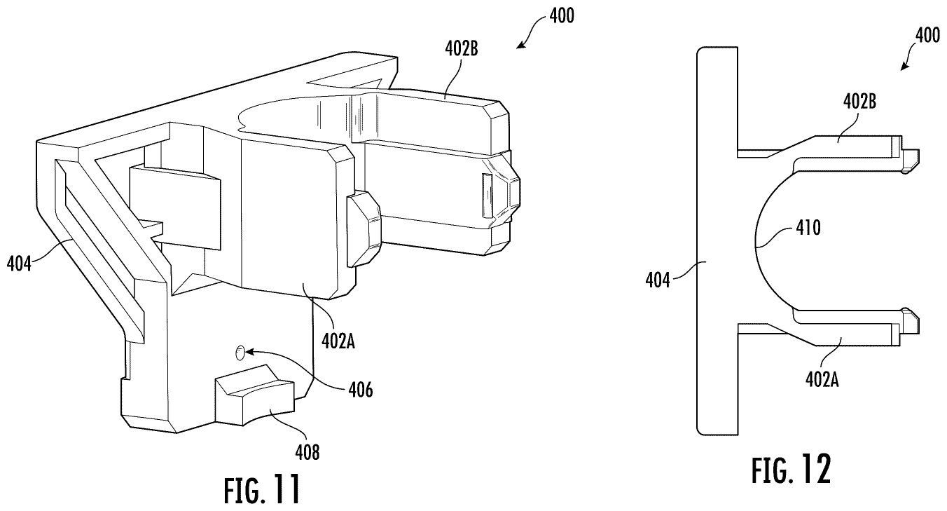

Referring now to FIGS. 11 and 12, two perspective views of a mounting connector 400 are illustrated in accordance with embodiments of the present disclosure, such as the mounting connector 400 that may be included in the mounting connector system 500 described above with reference to FIGS. 3 through 6. As shown, the mounting connector 400 may include a bracket body 404 and a pair of connector arms 402A, 402B extending from the bracket body 402. The pair of connector arms 402A, 402B may include a first connector arm 402A and a second connector arm 402B. In many embodiments, the pair of connector arms 402A, 402B may be spaced apart from one another (e.g., approximately the width of the elongate pole 200), and the pair of connector arms 404A, 402B may be generally parallel to one another.

The mounting connector 400 may mount to a vertical surface, such as a wall or a wall rail. For instance, the bracket body 404 of the mounting connector 400 may be a Y-bracket that is mountable to the Ryobi LINK wall rail or to a wall. The bracket body may include one or more holes 406 in the bracket body 404 for receiving a fastener therethrough to mount the mounting connector 400 to a wall via a screw or nail. Additionally, a stopper 408 (such as a rubber stopper) may extend from the bracket body 404 that supports the accessory connector 300 and/or the elongate pole 200 when coupled thereto. Further, the mounting connector 400 may include an arcuate back surface 410 extending between the first connector arm 402A and the second connector arm 402B.

When the accessory connector 300 is mounted onto the mounting connector 400 via the pair of mounting connector arms 402A, 402B at the pair of apertures 302A, 302B through which the pair of buttons 202A, 202B extend (as shown in FIGS. 5 and 6, the accessory connector 300 (and accessory, if connected thereto) can be mounted to the vertical surface simultaneously with the elongate pole 200 being released from the accessory connector 300. Thus, the accessory can be mounted, e.g., for storage, while the elongate pole 200 can be used with a different accessory or stored separately from the accessory.

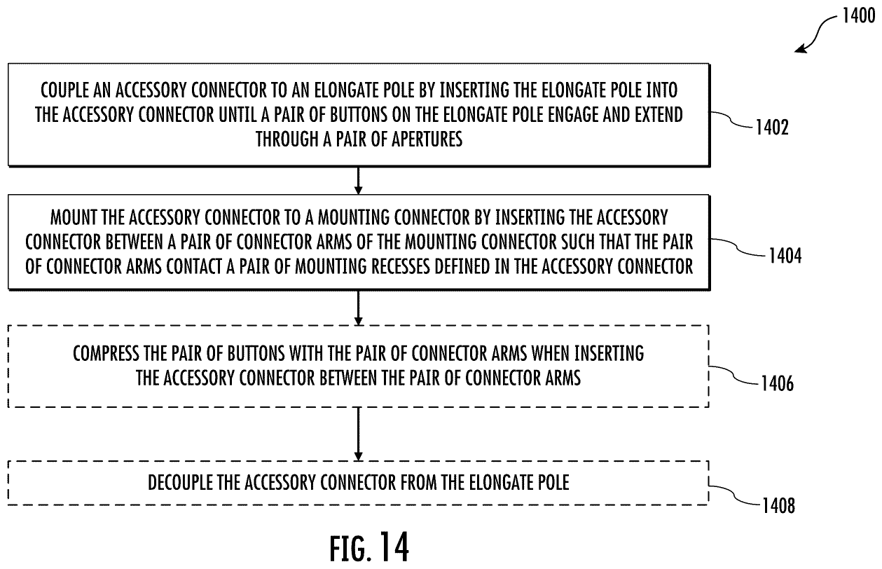

Referring now to FIG. 14, a flow diagram of one embodiment of a method 1400 of using a mounting connector system is illustrated in accordance with embodiments of the present subject matter. In general, the method 1400 will be described herein with reference to the mounting connector system 500, the elongate pole 200, the accessory connector 300, and the mounting connector 400 described above with reference to FIGS. 1-12. However, it will be appreciated by those of ordinary skill in the art that the disclosed method 1400 may generally be utilized with any other suitable system configuration. In addition, although FIG. 14 depicts steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, and/or adapted in various ways without deviating from the scope of the present disclosure. Dashed boxes indicate optional steps of the method 1400.

In many implementations, the method 1400 may include at (1402) coupling an accessory connector to an elongate pole by inserting the elongate pole into the accessory connector until a pair of buttons on the elongate pole engage and extend through a pair of apertures. Additionally, the method may include at (1404) mounting the accessory connector to a mounting connector by inserting the accessory connector between a pair of connector arms of the mounting connector such that the pair of connector arms contact a pair of mounting recesses defined in the accessory connector. In some embodiments, the method 1400 may include at (1406) compressing the pair of buttons with the pair of connector arms when inserting the accessory connector between the pair of connector arms. The connector arms may force the buttons to be within the accessory connector such that the elongate pole is removable from the accessory connector while the accessory connector remains mounted to the mounting connector. In some embodiments, the method 1400 may further include at (1408) decoupling the accessory connector from the elongate pole (e.g., by pulling the elongate pole out of an axial opening of the accessory connector).

In other embodiments, the method may further include providing an elongate pole having one or more buttons, and an accessory connector having an axial opening through which the elongate pole extends and connector apertures for each button of the elongate pole; pressing the buttons radially inward through the connector apertures to release engagement between the buttons and the connector apertures; and removing the elongate pole through the axial opening. The method may further include mounting the accessory connector to a mounting connector, the mounting connector having a pair of connector arms configured to align with the connector apertures of the accessory connector. In many implementations, the pair of connector arms of the mounting connector may press the buttons radially inward to automatically release the elongate pole from the accessory connector when the accessory connector is mounted to the mounting connector. The mounting step can be performed one-handed by inserting the elongate pole and accessory connector between the mounting connector arms, thereby releasing the elongate pole from the accessory connector one-handed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

An accessory connector for an elongate pole, the elongate pole defining a pair of buttons, the accessory connector comprising: a tubular main body extending from a first end to a second end, the tubular main body defining a pair of connector apertures between the first end and the second end, the accessory connector removably connectable to the elongate pole and movable between a disconnected position and a connected position in which the pair of buttons extend through the pair of connector apertures.

The accessory connector as in any preceding clause, wherein the tubular main body further comprises a pair of mounting recesses defined in an exterior surface of the tubular main body.

The accessory connector as in any preceding clause, wherein the pair of mounting recesses each have a bowtie shape.

The accessory connector as in any preceding clause, wherein the pair of mounting recesses each include a middle portion, a first wing portion extending from the middle portion, and a second wing portion extending from the middle portion.

The accessory connector as in any preceding clause, wherein the pair of connector apertures are aligned with and defined through the pair of mounting recesses.

The accessory connector as in any preceding clause, wherein the pair of mounting recesses comprises a first pair of mounting recesses and a second pair of mounting recesses axially spaced apart from each other.

The accessory connector as in any preceding clause, wherein the second pair of mounting recesses include a solid surface.

The accessory connector as in any preceding clause, wherein the pair of connector apertures are aligned with and defined through the first pair of mounting recesses.

The accessory connector as in any preceding clause, further comprising an accessory mounting portion extending from the second end of the tubular main body for connecting to an accessory.

A mounting connector system comprising: an elongate pole defining a pair of buttons; a mounting connector having a bracket body and a pair of connector arms extending from the bracket body; an accessory connector comprising a tubular main body extending from a first end to a second end, the tubular main body defining a pair of connector apertures and a pair of mounting recesses between the first end and the second end, the accessory connector removably connectable to the elongate pole and movable between a disconnected position and a connected position in which the pair of buttons extend through the pair of connector apertures.

The mounting connector system as in any preceding clause, wherein the accessory connector is mountable to the mounting connector and movable between an unmounted position and a mounted position in which the pair of connector arms extend into the pair of mounting recesses.

The mounting connector system as in any preceding clause, wherein the pair of connector arms contact and compress the pair of buttons when in the mounted position such that the elongate pole is removable from the accessory connector when in the mounted position.

The mounting connector system as in any preceding clause, wherein the pair of mounting recesses each have a bowtie shape.

The mounting connector system as in any preceding clause, wherein the pair of mounting recesses each include a middle portion, a first wing portion extending from the middle portion, and a second wing portion extending from the middle portion.

The mounting connector system as in any preceding clause, wherein the pair of connector apertures are aligned with and defined through the pair of mounting recesses.

The mounting connector system as in any preceding clause, wherein the pair of mounting recesses comprises a first pair of mounting recesses and a second pair of mounting recesses axially spaced apart from each other.

The mounting connector system as in any preceding clause, wherein the second pair of mounting recesses include a solid surface.

The mounting connector system as in any preceding clause, wherein the pair of connector apertures are aligned with and defined through the first pair of mounting recesses.

A method of using a mounting connector system, the method comprising: coupling an accessory connector to an elongate pole by inserting the elongate pole into the accessory connector until a pair of buttons on the elongate pole engage and extend through a pair of apertures; and mounting the accessory connector to a mounting connector by inserting the accessory connector between a pair of connector arms of the mounting connector such that the pair of connector arms contact a pair of mounting recesses defined in the accessory connector.

The method as in any preceding clause, further comprising: compressing the pair of buttons with the pair of connector arms when inserting the accessory connector between the pair of connector arms; and decoupling the accessory connector from the elongate pole.

What is claimed is:

1. An accessory connector for an elongate pole, the elongate pole defining a pair of buttons, the accessory connector comprising:
a tubular main body extending from a first end to a second end, the tubular main body defining a pair of connector apertures between the first end and the second end, the accessory connector removably connectable to the elongate pole and movable between a disconnected position and a connected position in which the pair of buttons extend through the pair of connector apertures.

2. The accessory connector as in claim 1, wherein the tubular main body further comprises a pair of mounting recesses defined in an exterior surface of the tubular main body.

3. The accessory connector as in claim 2, wherein the pair of mounting recesses each have a bowtie shape.

4. The accessory connector as in claim 2, wherein the pair of mounting recesses each include a middle portion, a first wing portion extending from the middle portion, and a second wing portion extending from the middle portion.

5. The accessory connector as in claim 2, wherein the pair of connector apertures are aligned with and defined through the pair of mounting recesses.

6. The accessory connector as in claim 2, wherein the pair of mounting recesses comprises a first pair of mounting recesses and a second pair of mounting recesses axially spaced apart from each other.

7. The accessory connector as in claim 6, wherein the second pair of mounting recesses include a solid surface.

8. The accessory connector as in claim 6, wherein the pair of connector apertures are aligned with and defined through the first pair of mounting recesses.

9. The accessory connector as in claim 1, further comprising an accessory mounting portion extending from the second end of the tubular main body for connecting to an accessory.

10. A mounting connector system comprising:
an elongate pole defining a pair of buttons;
a mounting connector having a bracket body and a pair of connector arms extending from the bracket body;
an accessory connector comprising a tubular main body extending from a first end to a second end, the tubular main body defining a pair of connector apertures and a pair of mounting recesses between the first end and the second end, the accessory connector removably connectable to the elongate pole and movable between a disconnected position and a connected position in which the pair of buttons extend through the pair of connector apertures.

11. The mounting connector system as in claim 10, wherein the accessory connector is mountable to the mounting connector and movable between an unmounted position and a mounted position in which the pair of connector arms extend into the pair of mounting recesses.

12. The mounting connector system as in claim 11, wherein the pair of connector arms contact and compress the pair of buttons when in the mounted position such that the elongate pole is removable from the accessory connector when in the mounted position.

13. The mounting connector system as in claim 10, wherein the pair of mounting recesses each have a bowtie shape.

14. The mounting connector system as in claim 10, wherein the pair of mounting recesses each include a middle portion, a first wing portion extending from the middle portion, and a second wing portion extending from the middle portion.

15. The mounting connector system as in claim 10, wherein the pair of connector apertures are aligned with and defined through the pair of mounting recesses.

16. The mounting connector system as in claim 10, wherein the pair of mounting recesses comprises a first pair of mounting recesses and a second pair of mounting recesses axially spaced apart from each other.

17. The mounting connector system as in claim 16, wherein the second pair of mounting recesses include a solid surface.

18. The mounting connector system as in claim 16, wherein the pair of connector apertures are aligned with and defined through the first pair of mounting recesses.

19. A method of using a mounting connector system, the method comprising:
coupling an accessory connector to an elongate pole by inserting the elongate pole into the accessory connector until a pair of buttons on the elongate pole engage and extend through a pair of apertures; and
mounting the accessory connector to a mounting connector by inserting the accessory connector between a pair of connector arms of the mounting connector such that the pair of connector arms contact a pair of mounting recesses defined in the accessory connector.

20. The method as in claim 19, further comprising:
compressing the pair of buttons with the pair of connector arms when inserting the accessory connector between the pair of connector arms; and
decoupling the accessory connector from the elongate pole.
